(19) United States
(12) Patent Application Publication
(10) Pub. No.: US 2025/0342672 A1
(43) Pub. Date: Nov. 6, 2025

(54) SHOOTING CONTROL METHOD, EXTENDED REALITY DEVICE AND COMPUTER READABLE STORAGE MEDIUM

(71) Applicant: RayNeo Co., Ltd., Shenzhen (CN)

(72) Inventors: Qionglin OUYANG, Shenzhen (CN); Xidong WANG, Shenzhen (CN)

(73) Assignee: RayNeo Co., Ltd., Shenzhen (CN)

(21) Appl. No.: 19/271,685

(22) Filed: Jul. 16, 2025

(30) Foreign Application Priority Data
Nov. 21, 2024 (CN) 202411671948.X

(51) Int. Cl. G06T 19/00; G06F 3/01; H04N 23/62

(52) U.S. Cl. CPC G06T 19/006; G06F 3/013; H04N 23/62

(57) ABSTRACT

A shooting control method applied in an extended reality device includes: collecting user's gaze point information indicative of a real scene image that a user is gazing at through a physical display screen of the extended reality device; displaying, by a virtual display screen, a marking frame indicative of a focus of the real scene image according to the gaze point information; and shooting the real scene image within the marking frame to generate a target image in response to a shooting control instruction, a technical solution of shooting the real scene image within the marking frame to generate a target image, directly framing and shooting in the real scene within the user's real field of view according to the user's gaze point information, thereby achieving the technical effect of improving the accuracy of scene selection and improving shooting clarity.

### CROSS REFERENCE TO RELATED APPLICATION

This application is a US national phase application which claims the priority of Chinese Patent Application No. 202411671948.X, entitled “SHOOTING CONTROL METHOD, APPARATUS, EXTENDED REALITY DEVICE AND COMPUTER READABLE STORAGE MEDIUM”, filed on Nov. 21, 2024, the disclosure of which is incorporated herein by reference in its entirety.

### FIELD OF THE INVENTION

The present disclosure relates to the application field of extended reality display technology, more particularly, to a shooting control method, an extended reality device, and computer-readable storage medium.

### BACKGROUND

Extended Reality (XR) technology enables users to interact with the virtual and real worlds by overlaying virtual objects, images, videos or other digital content on the real world. Wearable XR terminal devices represented by smart glasses are considered to be the best application carriers for “XR+AI” technology, integrating rich functional applications such as communication, music, photography, navigation, translation, health detection, etc.

When users use existing extended reality devices to take photos, for example, using AR glasses, they mostly use cameras embedded in the frame to obtain real-time environmental images within a fixed viewing angle as the glasses move, and present them in a selection box on the virtual screen through extended reality display. The user then determines the target image in the selection box on the virtual screen and finally performs the photo operation.

However, the existing shooting methods have low scene selection accuracy and poor picture clarity, which cannot meet the needs of users and affect the user experience. On the other hand, after focusing, the real scene to be shot is shot and streamed to the device for users to preview in the marking frame, which occupies the computing and storage resources of the device and increases the power consumption of the device.

### SUMMARY

An embodiment of the present disclosure is directed to a shooting control method, an extended reality device and computer-readable storage medium. The embodiment of the present disclosure can improve the accuracy of scene selection when shooting with an extended reality device, thereby improving shooting clarity.

In a first aspect of the present disclosure, a shooting control method applied in an extended reality device includes: collecting user's gaze point information indicative of a real scene image that a user is gazing at through a physical display screen of the extended reality device; displaying, by a virtual display screen, a marking frame indicative of a focus of the real scene image according to the gaze point information; and shooting the real scene image within the marking frame to generate a target image in response to a shooting control instruction.

Optionally, the collecting user's gaze point information comprises: acquiring eye image information of the user through an eye tracking module of the extended reality device; determining a pupil center position and an eyeball rotation angle according to the eye image information; and determining the gaze point information according to the pupil center position and the eyeball rotation angle.

Optionally, the displaying, by the virtual display screen, the marking frame indicative of a focus of the real scene image according to the gaze point information comprises: determining display position parameters of the marking frame according to a relationship between the gaze point information and a first pose of the extended reality device; determining display size parameters of the marking frame according to shooting parameters generated by a shooting module; and generating the marking frame according to the display position parameters and the display size parameters.

Optionally, the generating the marking frame according to the display position parameters and the display size parameters comprises: generating a first marking frame according to the display position parameters and the display size parameters; obtaining profile information of a target object when the target object exists in the real scene image within the first marking frame; generating a second marking frame within the first marking frame according to the profile information; and determining the marking frame from the first marking frame and the second marking frame in response to a selection control instruction, wherein the first marking frame and the second marking frame have different presentation forms.

Optionally, after determining the marking frame from the first marking frame and the second marking frame in response to the selection control instruction, the method further comprises: adjusting the shooting parameters according to the marking frame.

Optionally, the shooting the real scene image within the marking frame to generate the target image in response to the shooting control instruction further comprises: determining the eye position of the user through a sight tracking module of the extended reality device; determining a module position of the shooting module of the extended reality device; determining a second posture relationship according to the eyeball position and the module position; and calculating an original photo taken by the shooting module according to the second posture relationship to obtain the target image corresponding to the real scene image.

Optionally, the shooting the real scene image within the marking frame to generate the target image in response to the shooting control instruction comprises: receiving the shooting control instruction; shooting the real scene image according to the shooting control instruction to generate the target image.

In a second aspect of the present disclosure, an extended reality device includes a memory storing instructions, and a processor configured to execute program instructions to perform operations comprising: collecting user's gaze point information indicative of a real scene image that a user is gazing at through a physical display screen of the extended reality device; displaying, by a virtual display screen, a marking frame indicative of a focus of the real scene image according to the gaze point information; and shooting the real scene image within the marking frame to generate a target image in response to a shooting control instruction.

Optionally, the collecting user's gaze point information comprises: acquiring eye image information of the user through an eye tracking module of the extended reality device; determining a pupil center position and an eyeball rotation angle according to the eye image information; and determining the gaze point information according to the pupil center position and the eyeball rotation angle.

Optionally, the displaying, by the virtual display screen, the marking frame indicative of a focus of the real scene image according to the gaze point information comprises: determining display position parameters of the marking frame according to a relationship between the gaze point information and a first pose of the extended reality device; determining display size parameters of the marking frame according to shooting parameters generated by a shooting module; and generating the marking frame according to the display position parameters and the display size parameters.

Optionally, the generating the marking frame according to the display position parameters and the display size parameters comprises: generating a first marking frame according to the display position parameters and the display size parameters; obtaining profile information of a target object when the target object exists in the real scene image within the first marking frame; generating a second marking frame within the first marking frame according to the profile information; and determining the marking frame from the first marking frame and the second marking frame in response to a selection control instruction, wherein the first marking frame and the second marking frame have different presentation forms.

Optionally, after determining the marking frame from the first marking frame and the second marking frame in response to the selection control instruction, the method further comprises: adjusting the shooting parameters according to the marking frame.

Optionally, the shooting the real scene image within the marking frame to generate the target image in response to the shooting control instruction further comprises: determining the eye position of the user through a sight tracking module of the extended reality device; determining a module position of the shooting module of the extended reality device; determining a second posture relationship according to the eyeball position and the module position; and calculating an original photo taken by the shooting module according to the second posture relationship to obtain the target image corresponding to the real scene image.

Optionally, the shooting the real scene image within the marking frame to generate the target image in response to the shooting control instruction comprises: receiving the shooting control instruction; shooting the real scene image according to the shooting control instruction to generate the target image.

In a third aspect of the present disclosure, a non-transitory computer-readable storage medium, storing program instructions executable by a processor to perform operations comprising: collecting user's gaze point information indicative of a real scene image that a user is gazing at through a physical display screen of the extended reality device; displaying, by a virtual display screen, a marking frame indicative of a focus of the real scene image according to the gaze point information; and shooting the real scene image within the marking frame to generate a target image in response to a shooting control instruction.

Optionally, the collecting user's gaze point information comprises: acquiring eye image information of the user through an eye tracking module of the extended reality device; determining a pupil center position and an eyeball rotation angle according to the eye image information; and determining the gaze point information according to the pupil center position and the eyeball rotation angle.

Optionally, the displaying, by the virtual display screen, the marking frame indicative of a focus of the real scene image according to the gaze point information comprises: determining display position parameters of the marking frame according to a relationship between the gaze point information and a first pose of the extended reality device; determining display size parameters of the marking frame according to shooting parameters generated by a shooting module; and generating the marking frame according to the display position parameters and the display size parameters.

Optionally, the generating the marking frame according to the display position parameters and the display size parameters comprises: generating a first marking frame according to the display position parameters and the display size parameters; obtaining profile information of a target object when the target object exists in the real scene image within the first marking frame; generating a second marking frame within the first marking frame according to the profile information; and determining the marking frame from the first marking frame and the second marking frame in response to a selection control instruction, wherein the first marking frame and the second marking frame have different presentation forms.

Optionally, after determining the marking frame from the first marking frame and the second marking frame in response to the selection control instruction, the method further comprises: adjusting the shooting parameters according to the marking frame.

Optionally, the shooting the real scene image within the marking frame to generate the target image in response to the shooting control instruction further comprises: determining the eye position of the user through a sight tracking module of the extended reality device; determining a module position of the shooting module of the extended reality device; determining a second posture relationship according to the eyeball position and the module position; and calculating an original photo taken by the shooting module according to the second posture relationship to obtain the target image corresponding to the real scene image.

Optionally, the shooting the real scene image within the marking frame to generate the target image in response to the shooting control instruction comprises: receiving the shooting control instruction; shooting the real scene image according to the shooting control instruction to generate the target image.

In summary, the embodiments of the present disclosure collecting user's gaze point information indicative of a real scene image that a user is gazing at through a physical display screen of the extended reality device; displaying, by a virtual display screen, a marking frame indicative of a focus of the real scene image according to the gaze point information; and shooting the real scene image within the marking frame to generate a target image in response to a shooting control instruction, a technical solution of shooting the real scene image within the marking frame to generate a target image, directly framing and shooting in the real scene within the user's real field of view according to the user's gaze point information, thereby achieving the technical effect of improving the accuracy of scene selection and improving shooting clarity.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a block diagram of an extended reality device according to an embodiment of the present disclosure.

FIG. 2 is a flowchart of a shooting control method according to an embodiment of the present disclosure.

FIG. 3 illustrates an extended reality device according to an embodiment of the present disclosure.

FIG. 4 is a flow chart of the shooting control method according to another embodiment of the present disclosure.

FIG. 5 is a block diagram of a shooting control device according to another embodiment of the present disclosure.

FIG. 6 is a block diagram of the structure of an extended reality device provided in an embodiment of the present disclosure.

### DESCRIPTION OF THE EMBODIMENTS

To help a person skilled in the art better understand the solutions of the present disclosure, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present disclosure.

In the description of the present invention, it should be understood that the terms “center”, “longitudinal”, “lateral”, “length”, “width”, “thickness”, “up”, “down”, “front”, “back”, “left”, “right”, “vertical”, “horizontal”, “top”, “bottom”, “inside”, “outside” and the like indicate positions or positional relationships based on the positions or positional relationships shown in the accompanying drawings, and are only for the convenience of describing the present invention and simplifying the description, rather than indicating or implying that the device or element referred to must have a specific orientation, be constructed and operated in a specific orientation, and therefore cannot be understood as limiting the present invention. In addition, the terms “first” and “second” are only used for descriptive purposes, and cannot be understood as indicating or implying relative importance or implicitly indicating the number of technical features indicated. Therefore, the features defined as “first” and “second” may explicitly or implicitly include one or more of the above features. In the description of the present invention, the meaning of “multiple” is two or more, unless otherwise clearly and specifically defined.

In this application, the word “exemplary” is used to mean “serving as an example, illustration, or illustration.” Any embodiment described in this application as “exemplary” is not necessarily to be construed as being preferred or advantageous over other embodiments. The following description is given to enable any person skilled in the art to implement and use the invention. In the following description, details are listed for the purpose of explanation. It should be understood that a person of ordinary skill in the art can recognize that the invention can be implemented without using these specific details. In other instances, well-known structures and processes are not elaborated in detail to avoid obscuring the description of the invention with unnecessary details. Therefore, the present invention is not intended to be limited to the embodiments shown, but is consistent with the widest scope consistent with the principles and features disclosed in this application.

First, the terms involved in this application are explained:

Extended Reality: Extended Reality (XR) is a technology that creates an enhanced perceptual environment by combining virtual information with real-world scenes.

Extended reality devices: used to integrate virtual content with the real world to provide an enhanced visual experience. These devices usually use head-mounted displays (HMDs), smart glasses, or other forms of wearable devices.

The embodiments of the present disclosure provide a shooting control method, an apparatus, an extended reality device, and a computer-readable storage medium. Specifically, the embodiments of the present disclosure provide a shooting control apparatus applicable to the shooting control method, the shooting control apparatus comprising an extended reality device and a main control apparatus of the extended reality device.

In the existing technology, with the rapid development and increasing maturity of extended reality display technology, the support of extended reality display and artificial intelligence large models has enabled extended reality devices to have rich and colorful functional applications. More and more wearable extended reality devices (such as VR headsets, AR glasses, etc.) have been launched on the market, and first-person perspective smart photography is one of the important functions.

However, existing extended reality devices such as wearable smart glasses are mainly completed through cameras embedded in the device. As the device moves, it obtains real-time environmental images within a fixed viewing angle range relative to the user's viewing angle. The camera takes real-time photos of the environment and pushes the images to the extended reality display light machine. The images are presented in the virtual screen's selection box (marking frame) through the extended reality display for the user to preview. The user then determines the target image in the virtual screen's selection box and finally performs a photo operation on the target image.

However, this shooting method cannot meet the needs of users to directly frame within the real field of view and directly capture clear images within the ideal framing area, which affects the user experience of AR glasses. In addition, the existing shooting method also requires the image to be shot to be pushed to the selection box after shooting, which occupies the computing and storage resources of the device and also increases the power consumption of the device.

Therefore, the existing shooting methods of extended reality devices have many problems such as low scene selection accuracy, poor shooting picture clarity, and failure to meet user needs, which affects the user experience.

The embodiments of the present disclosure provide a shooting control method, device, extended reality device, and computer-readable storage medium. The method adopts a technical solution of obtaining the user's gaze point information, where the gaze point information is used to represent the real scene screen that the user is looking at through the physical display screen of the extended reality device; generating a marking frame on the virtual display screen according to the gaze point information, where the marking frame is used to represent the focus of the real scene screen; and responding to the shooting control instruction, shooting the real scene screen in the marking frame to generate a target image. The shooting control method in the embodiment of the present disclosure can directly frame and shoot in the real scene within the user's real field of view according to the user's gaze point information, thereby achieving the technical effect of improving the accuracy of scene selection and improving shooting clarity. At the same time, there is no need to shoot the real scene and stream it to the marking frame on the device side for user preview before the formal shooting, which saves the computing resources of the device and reduces the energy consumption of the device.

It should be noted that the order of description of the following embodiments is not intended to limit the priority order of the embodiments.

Please refer to FIG. 1 illustrating a block diagram of an extended reality device according to an embodiment of the present disclosure. The shooting control system may include an extended reality device 100 and a main control device 200. The extended reality device 100 and the main control device 200 may be connected to each other in any manner, including but not limited to signal communication through electronic circuits, communication through wireless signals. The wireless signals may be computer network communications of the TCP/IP Protocol Suite (TCP/IP) and the User Datagram Protocol (UDP). The extended reality device 100 may receive control signals from a remote control or a control panel, and the extended reality device 100 may also receive instruction information sent by the main control device 200. The extended reality device 100 may perform corresponding operations according to the corresponding instruction information, such as the shooting control method in the present disclosure.

In the embodiment of the present disclosure, the extended reality device 100 includes but is not limited to a head-mounted display (HMD), smart glasses, or other forms of wearable devices.

Those skilled in the art will understand that the application environment shown in FIG. 1 is merely one application scenario of the present disclosure scheme and does not constitute a limitation on the application scenario of the present disclosure scheme. Other application environments may also include more or fewer extended reality devices than shown in FIG. 1. For example, only one extended reality device is shown in FIG. 1, and no specific limitation is made here.

In addition, as shown in FIG. 1, the main control device 200 may include any hardware device capable of data processing and command transmission, such as a central processing unit (CPU) or a single-chip microcomputer embedded in the extended reality device 100, which is not specifically limited here. The main control device 200 may be any hardware device capable of data processing and command transmission, such as a CPU or a single-chip microcomputer embedded in other wearable devices such as mobile phones, bracelets, iPads, and wristbands, which is not specifically limited here.

It should be noted that the scene diagram of the shooting control system shown in FIG. 1 is merely an example. The shooting control system and scene described in the embodiment of the present disclosure are intended to more clearly illustrate the technical solution of the embodiment of the present disclosure, and do not constitute a limitation on the technical solution provided in the embodiment of the present disclosure. Ordinary technicians in this field can know that with the evolution of shooting control systems and the emergence of new business scenarios, the technical solution provided in the embodiment of the present disclosure is also applicable to similar technical problems.

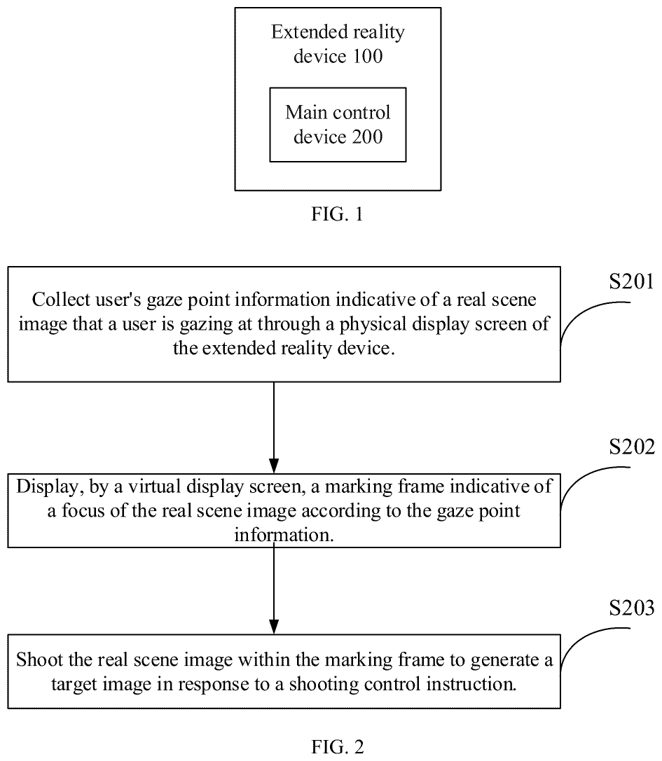

Specifically, please refer to FIG. 2 illustrating a flow chart of the extended reality device provided in the embodiment of the present disclosure executing the shooting control method. The specific execution process of the extended reality device executing the shooting control method is as follows:
S201: Collect user's gaze point information indicative of a real scene image that a user is gazing at through a physical display screen of the extended reality device.

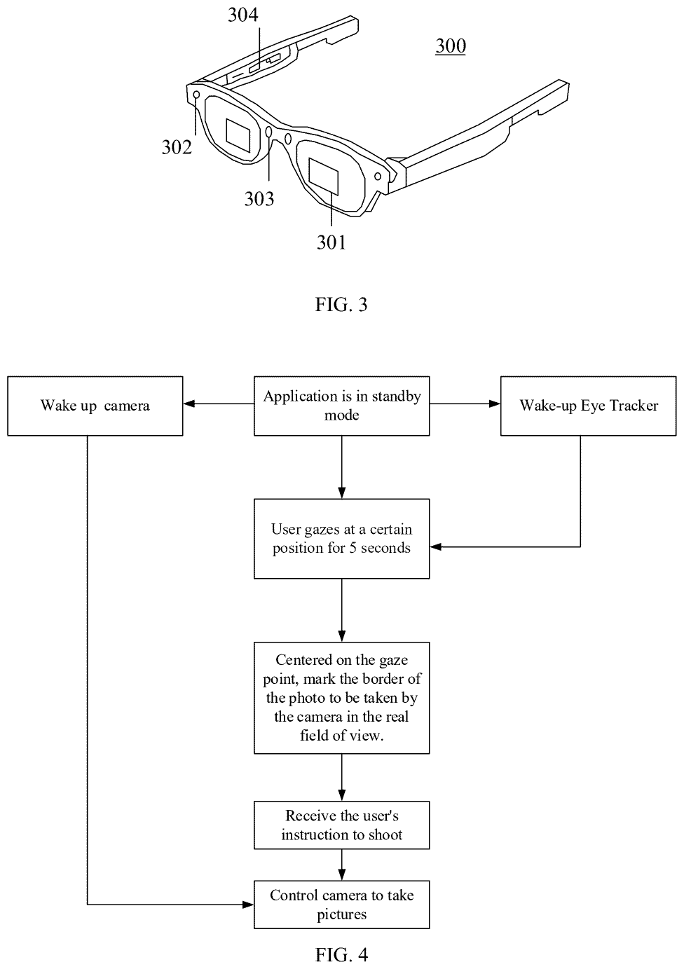

As an optional embodiment, as illustrated in the block diagram of the extended reality device in FIG. 3, the shooting control method provided in the present disclosure is applicable to the extended reality device. Taking AR glasses 300 as an example, in addition to the temples and frames of traditional glasses, the AR glasses also have a physical display screen 301 (including an optical display module including an optical combiner), a shooting module 302, a sight tracking module 303, and a computing and processing module 304.

It should be noted that the installation positions of the above modules in FIG. 3 are only examples and may be changed according to the specific structure of the extended reality device.

Optionally, the optical display module includes an ultra-small optical engine and an optical coupler. The optical engine can be based on micro-LED or micro-OLED. The optical coupler can be based on an optical waveguide or a semi-reflective and semi-transparent lens. In this embodiment, the optical combiner is arranged on the glass lens, that is, the whole or a part of the glass lens, so the real scene image that the user looks at through the physical display screen of the extended reality device is the real scene image that the user looks at through the glass lens.

Optionally, the camera module can be a camera with an image sensor. The camera module can take photos of the external environment that the user wants to take, and the camera faces the outward side of the extended reality device. The extended reality device can also have other cameras, such as a camera for eye tracking, a camera for gesture tracking, and a camera for lower body posture capture.

Optionally, the gaze tracking module can be an eye tracker that can directly output the position of the user's gaze point. It can be a module composed of cameras corresponding to the left and right eyes respectively and a computing processor that executes a specific algorithm program. The camera is used to take pictures of the user's left and right eyes, and the user's eye physiological characteristics data is processed to finally obtain the user's gaze point position.

It should be noted that the eye tracking module is one of the core components of the extended reality device to execute the shooting control method. It is responsible for capturing the user's eye movement information in real time. The module is usually composed of one or more high-precision cameras and can be installed inside the AR glasses and directly aimed at the user's eyes.

Optionally, the computing processing module is a chip that integrates one or more processing units such as a Central Processing Unit (CPU), a Graphics Processing Unit (GPU), a Neural Processing Unit (NPU), a Digital Signal Processor (DSP).

It should be noted that the extended reality device of the embodiment of the present disclosure mainly includes the above modules, and may also have an acoustic module, a communication module, a sensor module, etc. The acoustic module may include a speaker and a microphone, and the communication module may be Bluetooth communication, 5G communication, etc., so as to operate or control the extended reality device in a variety of ways. The sensor module may include a Global Positioning System (GPS), an Inertial Measurement Unit (IMU), a gyroscope, which can be used to achieve tracking and positioning.

In some embodiments of the present disclosure, when the camera function is turned on, the computing and processing module can obtain the exact position of the user's gaze point at this time from the sight tracking module.

Optionally, the shooting control method provided in the embodiment of the present disclosure also includes: obtaining eye image information of the user through the sight tracking module of the extended reality device; determining the pupil center position and the eye rotation angle based on the eye image information; determining the gaze point information based on the pupil center position and the eye rotation angle.

As an optional embodiment, as shown in the flow chart of the shooting control method in FIG. 4, before obtaining the user's gaze point information, the user can activate the shooting function of the AR glasses through voice commands, such as starting to shoot, or gestures, such as drawing a shooting symbol in the air. After receiving the start command, the computing processing module immediately controls the relevant application to enter the standby state, loads the relevant shooting module and initializes the various parameters of the sight tracking module, such as waking up the eye tracker, waking up the camera, etc., to ensure that the system can quickly respond to the user's next operation.

Optionally, after entering the shooting standby state, the gaze tracking module monitors the user's gaze position in real time, and the computing and processing module is ready to receive and process the gaze point information from the gaze tracking module at any time to prepare for the subsequent shooting process.

As an optional embodiment, after receiving the gaze point information of the gaze tracking module, the user's gaze point position can be calculated by a related gaze point algorithm, and the position is the point that the user is focusing on in the field of vision at this time.

Specifically, as shown in FIG. 4, after the user gazes at a certain position for a certain period of time, for example, 5 seconds, the gaze tracking module obtains the user's eye image information. After the camera of the gaze tracking module captures the user's eye image, the user's pupil center position, eyeball rotation angle and other data can be obtained through a series of calculations and processing. Subsequently, using the pupil center position, eyeball rotation angle and other data, a related gaze point algorithm, such as the pupil center-corneal reflection method or a 3D eyeball model, is used to calculate the user's gaze point, that is, the specific position in the real scene that the user is looking at through the physical display screen of the extended reality device.

It should be noted that the calculated user gaze point data can be coordinates in three-dimensional space, which are used to represent the projected position of the user's line of sight in the real world. After receiving these gaze point data, the computing and processing module can use them for subsequent image processing and marking frame positioning processes, that is, the frame of the image to be captured can be marked in the user's real field of view with the gaze point as the center.
S202: Display a marking frame indicative of a focus of the real scene image on a virtual display screen according to the gaze point information.

In the embodiment of the present disclosure, the virtual display screen is relative to the physical display screen, which refers to the virtual display screen generated in front of the human eye after the light emitted by the optical machine passes through multiple propagation conversions of multiple optical components and enters the human eye. The user can also observe the real field of view through this physical display screen, that is, the virtual display screen is located in the real field of view of the person, and various virtual information can be superimposed and displayed on the virtual display screen. The focus of the real scene image refers to the geometric center point of the real scene image corresponding to the image to be photographed.

It should be noted that the extended reality device has an optical display module, including: an ultra-small optical machine and an optical coupler. The ultra-small optical machine usually includes a micro display screen and a lens made of liquid crystal or organic light-emitting diode (OLED) technology. The optical coupler can be an optical waveguide. Taking smart glasses as an example, the optical waveguide can be part or all of the glass lens. They are placed in the extended reality device, and the light emitted by the optical machine is transmitted and converted through optical components, and finally forms a virtual display screen in front of the user.

In an embodiment of the present disclosure, after the calculation and processing module comprehensively processes data such as the gaze point position, the internal and external parameters of the shooting module, and the internal and external parameters of the virtual screen, the position of the marking box on the virtual display screen is obtained.

In an embodiment of the present disclosure, the focus of the real scene to be captured is determined based on the gaze point information. Usually, the focus is the geometric center point of the marking frame to be generated. After confirming the focus position, the range outline of the real scene to be captured can be determined in combination with the internal and external parameters of the shooting module, and the geometric size and shape of the virtual marking frame can be determined based on the range outline, and the marking frame can be displayed on the virtual display screen.

Optionally, the shooting control method provided in the embodiment of the present disclosure also includes: determining the display position parameters of the marking frame based on the relationship between the gaze point information and the first posture of the extended reality device; determining the display size parameters of the marking frame based on the shooting parameters of the shooting module; and generating the marking frame based on the display position parameters and the display size parameters.

In the embodiment of the present disclosure, after the calculation and processing module receives the user's gaze point data, it will calculate the size and shape of the marking frame in combination with the shooting parameters of the shooting module.

Specifically, the actual position of the real scene to be captured is determined according to the gaze point information, and the posture relationship between the actual position and the extended reality device is determined; the posture relationship between the virtual image displayed on the virtual screen and the extended reality device can also be determined in combination with the internal and external parameters of the shooting module and the internal and external parameters of the virtual screen; according to the above posture relationship, the display position parameters of the marking frame on the virtual display screen can be determined; then, according to the shooting parameters of the shooting module of the extended reality device (for example: focal length, aperture, field of view angle and lens distortion coefficient, etc.), the display size of the marking frame is determined, and the marking frame is generated according to the display size and display position parameters.

It should be noted that the shooting parameters include the first parameter information of the shooting module (internal parameters, such as focal length, aperture, field of view angle and lens distortion coefficient.) and the second parameter information (external parameters, such as the installation position and angle of the shooting module relative to the glasses). These shooting parameters are used to accurately project the gaze point from the three-dimensional space to the two-dimensional plane of the captured image, and determine the size and shape of the photograph corresponding to the selected real scene. The calculation and processing module can determine the display position parameters of the marking frame based on the gaze point data (gaze point information) and the posture relationship, and further determine the display size based on the first parameter information, so as to generate the marking frame according to the display position parameters and the display size. The posture relationship may include position relationship and/or posture relationship, such as relative position, relative posture, etc.

In an embodiment of the present disclosure, the display position data (display position parameters and display size) of the marking frame can be determined only based on the first parameter information and the posture relationship. First, determine the real position corresponding to the focus position in the real scene, determine the device position of the extended reality device according to the sensor module, and then determine the relative posture relationship between the extended reality area and the extended reality device according to the focus real position and the device position. Secondly, obtain the display parameters of the virtual display screen relative to the extended reality device. The display parameters include the conversion matrix relationship between the coordinate system of the virtual display screen and the coordinate system of the extended reality device. After determining the relative posture of the extended reality area relative to the extended reality device and determining the conversion matrix relationship between the coordinate system of the virtual display screen and the coordinate system of the extended reality device, the position data of the virtual display can be calculated. According to the display data, the extended reality device can generate the marking frame at the specified correct position (the geometric center of the marking frame is aligned with the gaze point, that is, the focus of the photograph, which is the correct position).

It should be noted that the display parameters of the virtual display screen relative to the extended reality device are determined by the optical hardware parameters of the extended reality device, that is, the first parameter information, which is generally obtained through pre-calibration and stored in a storage chip built into the extended reality device.

As a possible embodiment, the computing and processing module can also determine the display position parameters of the marking frame according to the gaze point data (gaze point information) and the posture relationship, and then adjust the display position parameters according to the second parameter information, and further determine the display size according to the first parameter information, so as to generate the marking frame according to the adjusted display position parameters and display size. Before the image is officially captured, the shooting angle of the shooting module is adjusted to be consistent with the observation angle of the human eye.

Optionally, the shooting control method provided in the embodiment of the present disclosure also includes: determining the user's eye position through the line of sight tracking module of the extended reality device, and obtaining the module position of the shooting module of the extended reality device; determining a second posture relationship based on the eye position and the module position; and calculating and processing the original photo taken by the shooting module according to the second posture relationship to obtain a target image corresponding to the real scene image.

In the embodiment of the present disclosure, since there is a difference in the position of the shooting module of the extended display device and the human eye, the display position data (display position parameters and display size) of the marking frame can also be determined in combination with the first parameter information, the second parameter information and the posture relationship.

Specifically, first, determine the real position corresponding to the focus position in the real scene, determine the device position of the extended reality device according to the sensor module, and then determine the relative posture relationship between the reality area to be extended and the extended reality device according to the focus real position and the device position; secondly, obtain the display parameters of the virtual display screen relative to the extended reality device, the display parameters include the conversion matrix relationship between the coordinate system of the virtual display screen and the coordinate system of the extended reality device, after determining the relative posture of the extended reality area with respect to the extended reality device, and determining the conversion matrix relationship between the coordinate system of the virtual display screen and the coordinate system of the extended reality device, the position data of the virtual display can be calculated; further, the user's eye position and the module position of the shooting module can be obtained through the line of sight tracking module, and the relative posture relationship between the user's eye and the shooting module can be obtained; thereby adjusting the display position data according to the posture relationship, and displaying a marking frame on the adjusted display position data according to the display size determined by the shooting module, so that the picture captured by the shooting module is consistent with the picture observed by the human eye.

It should be noted that the second parameter information is mainly used to adjust the display position of the marking frame so that the picture taken by the shooting module is consistent with the picture observed by the human eye. The effect of ensuring the consistency of the picture can also be achieved by processing the captured image through computers and other devices.

Optionally, still as shown in FIG. 4, the calculation processing module first determines the display position parameters of the gaze point in the image based on the internal reference data of the camera and the user's gaze point data. Next, considering the external reference data of the camera, the calculation processing module adjusts the position of the gaze point according to the installation position and angle of the shooting module relative to the glasses to ensure that it is consistent with the gaze point in the real world. The adjustment process can use complex projection transformation algorithms. Through these algorithms, the system can accurately map the user's gaze point from the actual scene to the image captured by the camera, so that the image content obtained by the shooting module is consistent with the content of the real scene observed by the human eye. Similarly, the shooting angle of the image shot by the shooting module can also be consistent with the angle of the real scene observed by the human eye.

As a possible embodiment, a telescopic component can be provided for the shooting module so that when the image is actually shot, the shooting module is in the same straight line as the human eye and the angle of the real scene to be shot, thereby making the angle of the shot image consistent with the angle at which the human eye observes the real scene.

As a possible embodiment, the computing and processing module can also adjust the captured image according to the first parameter information, the second parameter information and the posture relationship after the image is formally captured, so that the angle of the captured image is consistent with the angle at which the human eye observes the real scene.

Before displaying the real scene image on the virtual display screen according to the gaze point information, optionally, the shooting control method provided in the embodiment of the present disclosure also includes: generating a first marking frame according to display position parameters and display size parameters; when there is a target object in the real scene image represented in the first marking frame, obtaining profile information of the target object; generating a second marking frame in the first marking frame according to the profile information; and determining the marking frame from the first marking frame and the second marking frame in response to a selection control instruction.

In the embodiment of the present disclosure, the first marking frame and the second marking frame may be displayed in different forms. For example, the first marking frame may be displayed by a solid line, and the second marking frame may be displayed by a dotted line.

Specifically, the embodiments of the present disclosure can further optimize the position and size of the marking frame according to the image features corresponding to the gaze point position, such as the outline of the target object or the shape of a specific object obtained by edge detection results, or regenerate a second marking frame corresponding to the outline of the target object or the shape of the object in the first marking frame, and ensure that the second marking frame accurately covers the area of interest to the user.

Optionally, for example, if the target object in the observed real scene is a water cup, a first marking frame is first generated according to the gaze point position, and the outline of the water cup can be further determined to be the outline of the target object. A second marking frame is generated according to the outline of the water cup, and the second marking frame is displayed in the first marking frame.

It should be noted that the target object can be one or more, and the positional relationship of the target objects can be an overlapping relationship, a partially overlapping relationship, a parallel relationship, etc. The first marking box and the second marking box can be displayed at the same time or only one of them can be displayed. The number of the second marking boxes can also be multiple, which is not specifically limited in the present disclosure.

Optionally, after the second marking frame is generated, the user can select the marking frame in a variety of ways, and confirm the final marking frame according to the selection result, so that the shooting module can shoot the picture in the marking frame.

It should be noted that the user can select the marking frame through gestures, voice or other devices connected to the extended reality device.

After generating a second marking frame within the first marking frame according to the annotation range, optionally, the shooting control method provided in the embodiment of the present disclosure further includes: adjusting shooting parameters of the shooting module according to the marking frame.

Optionally, if the marking frame selected by the user is the second marking frame, that is, the image the user wants to capture is the image within the second marking frame, for example: only want to capture the image of the water cup, the shooting parameters of the shooting module can be dynamically adjusted according to the size and range of the second marking frame to make the obtained image clearer.

Optionally, if the marking frame selected by the user is the first marking frame, that is, the image the user wants to capture is the image within the first marking frame, for example: if the user wants to capture an image of a water cup and the environment surrounding the water cup, the shooting parameters of the shooting module can be dynamically adjusted according to the size and range of the first marking frame (the first marking frame is generated based on the shooting parameters of the shooting module, so it is not necessary to adjust it) to make the obtained image clearer.

Optionally, the computing processing module can also be dynamically adjusted to cope with slight movements of the user's head or slight shifts in the line of sight. The marking frame can track the user's gaze point in real time and maintain the correct position in the image.

In the embodiment of the present disclosure, after the marking frame is generated, the computing processing module will directly overlay the marking frame on the user's virtual display screen, and the marking frame is the target image corresponding to the real scene screen. The computing processing module enters a waiting state at this time, waiting for the user's shooting confirmation instruction.

It should be noted that the display of the marking frame is realized through the optical display module, and the marking frame can also be covered on the area where the user is looking in a semi-transparent manner to ensure that it will not hinder the user's observation of the real scene.

Through the embodiments of the present disclosure, users can accurately select the real scene location and range of the photo they want to take in the real field of view in a natural interactive way in real time, and preview the photo they are about to take in the marked box in advance to determine whether to take the photo. The scene selection is accurate, the photos taken are clearer, and there is no need to continue the photo preview process in the alternative area or preview area, which reduces resource usage.

In an embodiment of the present disclosure, after the marking frame is generated, the computing and processing module can project the initial image corresponding to the real scene image in the marking frame into the marking frame on the virtual display screen, so that the user can preview the initial image without shooting.

In an embodiment of the present disclosure, after the marking frame is generated, the shooting parameters of the shooting module can be dynamically adjusted according to the annotation range of the marking frame, such as: focal length, aperture, field of view angle and lens distortion coefficient, etc.; so that the shooting parameters are consistent with the size of the marking frame range, thereby achieving a technical effect of clearer captured images.

In an embodiment of the present disclosure, after the marking frame is generated, the computing and processing module can project the real scene image in the marking frame into the marking frame on the virtual display screen, and generate a corresponding virtual image based on the initial image, add the virtual image to the initial image, generate a virtual and virtual reality combined image, and display it in the marking frame.
S203: Shoot the real scene image within the marking frame to generate a target image in response to a shooting control instruction.

Optionally, the shooting control method provided in the embodiment of the present disclosure also includes: receiving a shooting control instruction sent by a user; shooting and processing the real scene image according to the shooting control instruction to generate a target image.

In an embodiment of the present disclosure, the user can confirm the shooting in different ways, for example: continue to look at the marked box area for a period of time (such as 3 seconds), then the computing and processing module will automatically confirm that the user wants to shoot the area.

Optionally, the user can also explicitly issue a shooting command through voice commands, such as: take a photo.

Optionally, the user can also confirm the shooting through gestures.

It should be noted that during the confirmation process, the gaze tracking module will continue to track the user's gaze position to ensure that the marking frame can adjust its position at any time to adapt to the user's possible gaze movement.

As an optional embodiment, after the user confirms taking a photo by gaze, voice or gesture, the computing processing module immediately controls the shooting module to perform the shooting operation. The camera in the shooting module will quickly focus on the area covered by the marked box, perform necessary optimization such as automatic focus and exposure adjustment, and ensure that the captured image quality meets expectations.

Optionally, after shooting, the generated high-resolution image will first be stored in the local memory of the AR glasses for the user to view or edit immediately. At the same time, according to the user's settings, the image can be automatically uploaded to the cloud storage or transferred to the user's other devices, such as smartphones, tablets, etc., through the built-in communication module, such as Bluetooth, Wi-Fi or 5G communication, for backup and sharing.

Through the embodiments of the present disclosure, a technical solution is adopted for obtaining the user's gaze point information, wherein the gaze point information is used to represent the real scene image that the user is gazing at through the physical display screen of the extended reality device; generating a marking frame on the virtual display screen according to the gaze point information, wherein the marking frame is used to represent the focus of the real scene image; and responding to a shooting control instruction, shooting the real scene image in the marking frame to generate a target image. According to the user's gaze point information, the real scene within the user's real field of view is directly framed and photographed, thereby achieving the technical effect of improving the accuracy of scene selection and improving the clarity of shooting.

In order to better implement the shooting control method of the present disclosure, the present disclosure also provides a shooting control device based on the shooting control method. The meanings of the terms are the same as those in the shooting control method, and the specific implementation details can refer to the description in the method embodiment.

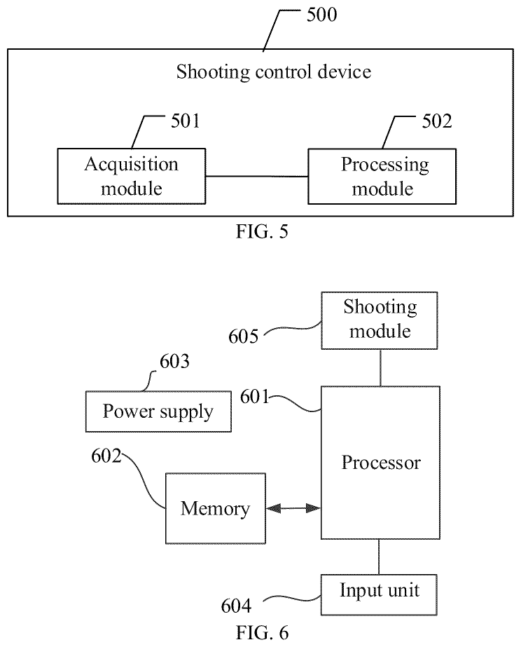

Please refer to FIG. 5 illustrating a block diagram of a shooting control device according to an embodiment of the present disclosure. The shooting control device 500 applied to an extended reality device includes an acquisition module 501, and a processing module 502

The acquisition module 501 is used to acquire user's gaze point information, wherein the gaze point information is used to represent a real scene image that the user gazes at through the physical display screen of the extended reality device;

The processing module 502 is used to generate a marking frame on a virtual display screen according to the gaze point information. The marking frame is used to represent the focus of the real scene image.

The processing module 502 is further configured to shoot the real scene image within the marking frame to generate a target image in response to a shooting control instruction.

Optionally, in some embodiments of the present disclosure, the acquisition module 501 is used to acquire eye image information of the user through an eye tracking module of the extended reality device, to determine a pupil center position and an eyeball rotation angle according to the eye image information, and to determine the gaze point information according to the pupil center position and the eyeball rotation angle.

Optionally, in some embodiments of the present disclosure, the processing module 502 is used to determine display position parameters of the marking frame according to a relationship between the gaze point information and a first pose of the extended reality device, to determine display size parameters of the marking frame according to shooting parameters generated by a shooting module, and to generate the marking frame according to the display position parameters and the display size parameters.

Optionally, in some embodiments of the present disclosure, the processing module 502 is further used to generate a first marking frame according to the display position parameters and the display size parameters, obtain profile information of a target object when the target object exists in the real scene image within the first marking frame, to generate a second marking frame within the first marking frame according to the profile information, and to determine the marking frame from the first marking frame and the second marking frame in response to a selection control instruction. The first marking frame and the second marking frame have different presentation forms.

Optionally, in some embodiments of the present disclosure, the processing module 502 is further used to adjust the shooting parameters of the shooting module according to the marking frame.

Optionally, in some embodiments of the present disclosure, the processing module 502 is further used to determine the eye position of the user through a sight tracking module of the extended reality device, determine a module position of the shooting module of the extended reality device, to determine a second posture relationship according to the eyeball position and the module position, and to calculate an original photo taken by the shooting module according to the second posture relationship to obtain the target image corresponding to the real scene image.

Optionally, in some embodiments of the present disclosure, the processing module 502 is further used to receive the shooting control instruction, and to shoot the real scene image according to the shooting control instruction to generate the target image.

In the embodiment of the present disclosure, the acquisition module 501 first acquires the user's gaze point information, wherein the gaze point information is used to represent the real scene image that the user is gazing at through the physical display screen of the extended reality device. Then, the processing module 502 generates a marking frame on the virtual display screen according to the gaze point information. The marking frame is used to represent the focus of the real scene image. Then, the processing module 502 responds to the shooting control instruction to shoot the real scene image in the marking frame to generate a target image.

The embodiments of the present disclosure collecting user's gaze point information indicative of a real scene image that a user is gazing at through a physical display screen of the extended reality device; displaying, by a virtual display screen, a marking frame indicative of a focus of the real scene image according to the gaze point information; and shooting the real scene image within the marking frame to generate a target image in response to a shooting control instruction, a technical solution of shooting the real scene image within the marking frame to generate a target image, directly framing and shooting in the real scene within the user's real field of view according to the user's gaze point information, thereby achieving the technical effect of improving the accuracy of scene selection and improving shooting clarity.

In addition, the present disclosure also provides an extended reality device, as shown in FIG. 6 illustrating a block diagram of the extended reality device according of an embodiment of the present disclosure.

The extended reality device may include components such as a processor 601 with one or more processing cores, a memory 602 with one or more computer-readable storage media, a power supply 603, an input unit 604, and a shooting module 605. Those skilled in the art will appreciate that the extended reality device structure shown in FIG. 6 does not constitute a limitation on the extended reality device, and may include more or fewer components than shown in the figure, or combine certain components, or arrange the components differently. Among them:

The processor 601 is the control center of the extended reality device, that is, the processing module, which uses various interfaces and lines to connect the various parts of the entire extended reality device, and executes various functions of the extended reality device and processes data by running or executing software programs and/or modules stored in the memory 602, and calling the data stored in the memory 602, so as to monitor the extended reality device as a whole. Optionally, the processor 601 may include one or more processing cores; preferably, the processor 601 may integrate an application processor and a modem processor, wherein the application processor mainly processes the operating system, user interface and application programs, and the modem processor mainly processes wireless communications. It is understandable that the above-mentioned modem processor may not be integrated into the processor 601.

The memory 602 can be used to store software programs and modules. The processor 601 executes various functional applications and data processing by running the software programs and modules stored in the memory 602. The memory 602 may mainly include a program storage area and a data storage area, wherein the program storage area may store an operating system, an application required for at least one function (such as a sound playback function, an image playback function, etc.), etc.; the data storage area may store data created according to the use of the extended reality device, etc. In addition, the memory 602 may include a high-speed random access memory, and may also include a non-volatile memory, such as at least one disk storage device, a flash memory device, or other volatile solid-state storage devices. Accordingly, the memory 602 may also include a memory controller to provide the processor 601 with access to the memory 602.

The extended reality device also includes a power supply 603 for supplying power to various components. Preferably, the power supply 603 can be logically connected to the processor 601 through a power management system, so as to manage charging, discharging, and power consumption through the power management system. The power supply 603 can also include one or more DC or AC power supplies, recharging systems, power supply device debugging circuits, power converters or inverters, power status indicators, and other arbitrary components.

The extended reality device may further include an input unit 604, which may be used to receive input digital or character information, and generate keyboard, mouse, joystick, optical or trackball signal input related to user settings and function control.

The extended reality device may further include a shooting module 605 which may be used to respond to a shooting control instruction and perform a shooting operation.

Although not shown, the extended reality device may also include a display unit, a sight tracking module, etc., which are not described in detail here. Specifically in this embodiment, the processor 601 in the extended reality device will load the executable file corresponding to the process of one or more application programs into the memory 602 according to the following instructions, and the processor 601 will run the application program stored in the memory 602, thereby implementing the steps in any one of the shooting control methods provided in the embodiments of the present disclosure.

The embodiments of the present disclosure proposes: collecting user's gaze point information indicative of a real scene image that a user is gazing at through a physical display screen of the extended reality device; displaying, by a virtual display screen, a marking frame indicative of a focus of the real scene image according to the gaze point information; and shooting the real scene image within the marking frame to generate a target image in response to a shooting control instruction, a technical solution of shooting the real scene image within the marking frame to generate a target image, directly framing and shooting in the real scene within the user's real field of view according to the user's gaze point information, thereby achieving the technical effect of improving the accuracy of scene selection and improving shooting clarity.

The specific implementation of the above operations can be found in the previous embodiments, which will not be described in detail here.

A person of ordinary skill in the art will appreciate that all or part of the steps in the various methods of the above embodiments may be completed by instructions, or by controlling related hardware through instructions. The instructions may be stored in a computer-readable storage medium and loaded and executed by a processor. The storage medium may include: Read Only Memory (ROM), Random Access Memory (RAM), magnetic disk or optical disk, etc.

Because of the instructions stored in the storage medium, the steps in any of the vehicle driving control methods provided by the embodiments of the present application can be executed, and therefore, any vehicle driving control methods provided by the embodiments of the present application can be implemented. For the beneficial effects that can be achieved, refer to the foregoing embodiments for details, which will not be repeated here.

In this specification, specific examples are applied to explain the principle and implementation of the present disclosure. The description of the above embodiments is only used to help understand the method and core idea of the present disclosure; meanwhile, for those skilled in the art, there will be changes in the specific implementation mode and application scope according to the idea of the present disclosure. To sum up, the contents of this specification should not be construed as limiting the present disclosure.

What is claimed is:

1. A shooting control method, applied in an extended reality device, the method comprising:
collecting user's gaze point information indicative of a real scene image that a user is gazing at through a physical display screen of the extended reality device;
displaying, by a virtual display screen, a marking frame indicative of a focus of the real scene image according to the gaze point information; and
shooting the real scene image within the marking frame to generate a target image in response to a shooting control instruction.

2. The method according to claim 1, wherein the collecting user's gaze point information comprises:
acquiring eye image information of the user through an eye tracking module of the extended reality device;
determining a pupil center position and an eyeball rotation angle according to the eye image information; and
determining the gaze point information according to the pupil center position and the eyeball rotation angle.

3. The method according to claim 1, wherein the displaying, by the virtual display screen, the marking frame indicative of a focus of the real scene image according to the gaze point information comprises:
determining display position parameters of the marking frame according to a relationship between the gaze point information and a first pose of the extended reality device;
determining display size parameters of the marking frame according to shooting parameters generated by a shooting module; and
generating the marking frame according to the display position parameters and the display size parameters.

4. The method according to claim 3, wherein the generating the marking frame according to the display position parameters and the display size parameters comprises:
generating a first marking frame according to the display position parameters and the display size parameters;
obtaining profile information of a target object when the target object exists in the real scene image within the first marking frame;
generating a second marking frame within the first marking frame according to the profile information; and
determining the marking frame from the first marking frame and the second marking frame in response to a selection control instruction, wherein the first marking frame and the second marking frame have different presentation forms.

5. The method according to claim 4, wherein after determining the marking frame from the first marking frame and the second marking frame in response to the selection control instruction, the method further comprises:
adjusting the shooting parameters according to the marking frame.

6. The method according to claim 1, wherein the shooting the real scene image within the marking frame to generate the target image in response to the shooting control instruction further comprises:
determining the eye position of the user through a sight tracking module of the extended reality device;
determining a module position of the shooting module of the extended reality device;
determining a second posture relationship according to the eyeball position and the module position; and
calculating an original photo taken by the shooting module according to the second posture relationship to obtain the target image corresponding to the real scene image.

7. The method according to claim 1, wherein the shooting the real scene image within the marking frame to generate the target image in response to the shooting control instruction comprises:
receiving the shooting control instruction;
shooting the real scene image according to the shooting control instruction to generate the target image.

8. An extended reality device, comprising:
a memory, storing instructions; and
a processor, configured to execute program instructions to perform operations comprising:
collecting user's gaze point information indicative of a real scene image that a user is gazing at through a physical display screen of the extended reality device;
displaying, by a virtual display screen, a marking frame indicative of a focus of the real scene image according to the gaze point information; and
shooting the real scene image within the marking frame to generate a target image in response to a shooting control instruction.

9. The extended reality device according to claim 8, wherein the collecting user's gaze point information comprises:
acquiring eye image information of the user through an eye tracking module of the extended reality device;
determining a pupil center position and an eyeball rotation angle according to the eye image information; and
determining the gaze point information according to the pupil center position and the eyeball rotation angle.

10. The extended reality device according to claim 8, wherein the displaying, by the virtual display screen, the marking frame indicative of a focus of the real scene image according to the gaze point information comprises:
determining display position parameters of the marking frame according to a relationship between the gaze point information and a first pose of the extended reality device;
determining display size parameters of the marking frame according to shooting parameters generated by a shooting module; and
generating the marking frame according to the display position parameters and the display size parameters.

11. The extended reality device according to claim 10, wherein the generating the marking frame according to the display position parameters and the display size parameters comprises:
generating a first marking frame according to the display position parameters and the display size parameters;
obtaining profile information of a target object when the target object exists in the real scene image within the first marking frame;
generating a second marking frame within the first marking frame according to the profile information; and
determining the marking frame from the first marking frame and the second marking frame in response to a selection control instruction, wherein the first marking frame and the second marking frame have different presentation forms.

12. The extended reality device according to claim 11, wherein after determining the marking frame from the first marking frame and the second marking frame in response to the selection control instruction, the operations further comprise:
adjusting the shooting parameters according to the marking frame.

13. The extended reality device according to claim 8, wherein the shooting the real scene image within the marking frame to generate the target image in response to the shooting control instruction further comprises:
determining the eye position of the user through a sight tracking module of the extended reality device;
determining a module position of the shooting module of the extended reality device;
determining a second posture relationship according to the eyeball position and the module position; and
calculating an original photo taken by the shooting module according to the second posture relationship to obtain the target image corresponding to the real scene image.

14. The extended reality device according to claim 8, wherein the shooting the real scene image within the marking frame to generate the target image in response to the shooting control instruction comprises:
receiving the shooting control instruction;
shooting the real scene image according to the shooting control instruction to generate the target image.

15. A non-transitory computer-readable storage medium, storing program instructions executable by a processor to perform operations comprising:
collecting user's gaze point information indicative of a real scene image that a user is gazing at through a physical display screen of the extended reality device;
displaying, by a virtual display screen, a marking frame indicative of a focus of the real scene image according to the gaze point information; and
shooting the real scene image within the marking frame to generate a target image in response to a shooting control instruction.

16. The non-transitory computer-readable storage medium according to claim 15, wherein the collecting user's gaze point information comprises:
acquiring eye image information of the user through an eye tracking module of the extended reality device;
determining a pupil center position and an eyeball rotation angle according to the eye image information; and
determining the gaze point information according to the pupil center position and the eyeball rotation angle.

17. The non-transitory computer-readable storage medium according to claim 15, wherein the displaying, by the virtual display screen, the marking frame indicative of a focus of the real scene image according to the gaze point information comprises:
determining display position parameters of the marking frame according to a relationship between the gaze point information and a first pose of the extended reality device;
determining display size parameters of the marking frame according to shooting parameters generated by a shooting module; and
generating the marking frame according to the display position parameters and the display size parameters.

18. The non-transitory computer-readable storage medium according to claim 17, wherein the generating the marking frame according to the display position parameters and the display size parameters comprises:
generating a first marking frame according to the display position parameters and the display size parameters;
obtaining profile information of a target object when the target object exists in the real scene image within the first marking frame;
generating a second marking frame within the first marking frame according to the profile information; and
determining the marking frame from the first marking frame and the second marking frame in response to a selection control instruction, wherein the first marking frame and the second marking frame have different presentation forms.

19. The non-transitory computer-readable storage medium according to claim 18, wherein after determining the marking frame from the first marking frame and the second marking frame in response to the selection control instruction, the operations further comprise:
adjusting the shooting parameters according to the marking frame.

20. The non-transitory computer-readable storage medium according to claim 15, wherein the shooting the real scene image within the marking frame to generate the target image in response to the shooting control instruction further comprises:
determining the eye position of the user through a sight tracking module of the extended reality device;
determining a module position of the shooting module of the extended reality device;
determining a second posture relationship according to the eyeball position and the module position; and
calculating an original photo taken by the shooting module according to the second posture relationship to obtain the target image corresponding to the real scene image.
